(19) United States
(12) Patent Application Publication
(10) Pub. No.: US 2017/0290278 A1
(43) Pub. Date: Oct. 12, 2017

(54) SETTING METHOD, CONTROLLING SYSTEM, CONTROLLING DEVICE, NON-TRANSITORY COMPUTER READABLE STORAGE MEDIUM AND IRRIGATION CONTROLLER

(71) Applicant: Aeon Matrix Inc., Taipei City (TW)

(72) Inventor: Ming-Je TSAI, Taipei City (TW)

(21) Appl. No.: 15/272,886

(22) Filed: Sep. 22, 2016

(30) Foreign Application Priority Data
Apr. 7, 2016 (TW) 105110965

(51) Int. Cl. A01G 25/16; G05B 15/02

(52) U.S. Cl. CPC A01G 25/165; A01G 25/167; G05B 15/02

(57) ABSTRACT

A control system including a control device, an irrigation controller and a server is disclosed. The server is linked to the control device and the irrigation controller for receiving a regional information of the irrigation controller. The regional information includes a position information of the irrigation controller, a plant information and a sprinkler information. The server generates a watering schedule according to the regional information and an evapotranspiration information corresponding to the position information. Then, the server transmits the watering schedule to both the irrigation controller and the control device, so that the irrigation controller is set up according to the watering schedule.

### CROSS REFERENCE TO RELATED APPLICATIONS

This Non-provisional application claims priority under 35 U.S.C. §119(a) on Patent Application No(s). 105110965 filed in Taiwan, Republic of China on Apr. 7, 2016, the entire contents of which are hereby incorporated by reference.

### BACKGROUND OF THE INVENTION

### Field of Invention

The present invention relates to a setting method, a control system, a control device, a non-transitory computer readable storage medium and an irrigation controller.

### Related Art

With the progress of technology, the parameters of many electronic apparatuses or systems, such as the operation time or period, can be directly set. Taking the irrigation system as an example, the operation parameters thereof are usually needed to be set up manually. For example, when to enable the irrigation system or how long the irrigation system is operated must be manually set up. However, the manually setting needs a professional operator, who must has sufficient gardening knowledge, to set up the system. If the irrigation system is not properly set up or the unexpected situations are incurred, the provided water by the irrigation system may be less than or more than the optimum watering amount, which will damage the plant or cause the waste of water.

### SUMMARY OF THE INVENTION

In view of the foregoing, an objective of the present invention is to provide a setting method, a control system, a control device, a non-transitory computer readable storage medium and an irrigation controller, which can assist to set up the parameters (e.g. watering time) so as to make the operation more convenience. Besides, the parameters can be set up with considering the local environment conditions. Accordingly, the performance of setting the watering schedule can be improved. Moreover, the user, who does not have the professional gardening knowledge, can still set up a proper watering schedule for the local environment.

To achieve the above objective, the present invention discloses a setting method of a watering schedule of an irrigation controller, which includes the following steps of: transmitting a regional information of the irrigation controller, which contains a position information, a plant information and a sprinkler information, to a server; generating the watering schedule by a server according to the regional information and an evapotranspiration information corresponding to the position information; transmitting the watering schedule from the server to a control device and the irrigation controller; and setting up the irrigation controller according to the watering schedule.

In one embodiment, the position information is an IP address of the irrigation controller, and the IP address is transmitted from the irrigation controller to the server.

In one embodiment, the position information is inputted by a user via the control device and then transmitted to the server.

In one embodiment, the position information is retrieved by a GPS module of the control device and then transmitted to the server.

In one embodiment, the server further renews the watering schedule according to a weather information and transmits the renewed water schedule to the control device and the irrigation controller.

In one embodiment, the server generates the watering schedule according to the regional information and the evapotranspiration information as well as a soil profile information.

To achieve the above objective, the present invention also discloses a control system, which includes a control device, an irrigation controller, and a server. The server is linked to the control device and the irrigation controller for receiving a regional information of the irrigation controller. The regional information includes a position information, a plant information and a sprinkler information of the irrigation controller. The server generates a watering schedule according to the regional information and an evapotranspiration information corresponding to the position information, and then transmits the watering schedule to the irrigation controller and the control device. The irrigation controller is set up according to the watering schedule.

In one embodiment, the position information is an IP address of the irrigation controller, and the IP address is transmitted from the irrigation controller to the server.

In one embodiment, the position information is inputted by a user via the control device and then transmitted to the server.

In one embodiment, the position information is retrieved by a GPS module of the control device and then transmitted to the server.

In one embodiment, the server further renews the watering schedule according to a weather information and transmits the renewed water schedule to the control device and the irrigation controller.

In one embodiment, the server generates the watering schedule according to the regional information and the evapotranspiration information as well as a soil profile information.

To achieve the above objective, the present invention also discloses a control device configured for linking with a server for setting a watering schedule of an irrigation controller. The control device includes one or more processing units and one or more storing units. The one or more storing units are coupled to the one or more processing units, and the one or more storing units store one or more instructions. When the one or more processing units execute the one or more instructions, the one or more processing units execute the following steps of: transmitting a regional information of the irrigation controller to the server, wherein the regional information comprises a position info nation, a plant information and a sprinkler information of the irrigation controller; and receiving a watering schedule transmitted from the server, wherein the server generates the watering schedule according to the regional information of the irrigation controller and an evapotranspiration information corresponding to the position information.

In one embodiment, the position information is inputted by a user via the control device and then transmitted to the server.

In one embodiment, the position info nation is retrieved by a GPS module of the control device and then transmitted to the server.

In one embodiment, the server further renews the watering schedule according to a weather information and transmits the renewed water schedule to the control device and the irrigation controller.

In one embodiment, the server generates the watering schedule according to the regional information and the evapotranspiration information as well as a soil profile information.

To achieve the above objective, the present invention further discloses a non-transitory computer readable storage medium applied to a control device, which links with a server for setting a watering schedule of an irrigation controller. The non-transitory computer readable storage medium includes at least one program, and the program is executed to perform the following steps of: transmitting a regional information of the irrigation controller to a server, wherein the regional information comprises a position information, a plant information and a sprinkler information of the irrigation controller; and receiving a watering schedule transmitted from the server, wherein the server generates the watering schedule according to the regional information of the irrigation controller and an evapotranspiration information corresponding to the position information.

In one embodiment, the position information is inputted by a user via the control device and then transmitted to the server.

In one embodiment, the position information is retrieved by a GPS module of the control device and then transmitted to the server.

In one embodiment, the server further renews the watering schedule according to a weather information and transmits the renewed water schedule to the control device and the irrigation controller.

In one embodiment, the server generates the watering schedule according to the regional information and the evapotranspiration information as well as a soil profile information.

To achieve the above objective, the present invention also discloses an irrigation controller, which links to a server and includes a transmitting unit and a processing unit. The transmitting unit links to the server, and the server receives a regional information of the irrigation controller. The regional information includes a position information, a plant information and a sprinkler information of the irrigation controller. The server generates a watering schedule according to the regional information of the irrigation controller and an evapotranspiration information corresponding to the position information. The transmitting unit receives the watering schedule from the server. The processing unit is coupled to the transmitting unit and sets up the irrigation controller according to the watering schedule.

In one embodiment, the irrigation controller further includes a storing unit coupled to the processing unit, and the watering schedule is stored in the storing unit.

In one embodiment, the position information is an IP address of the irrigation controller, and the IP address is transmitted from the irrigation controller to the server.

In one embodiment, the position information is inputted by a user via a control device and then transmitted to the server.

In one embodiment, the position information is retrieved by a GPS module of the control device and then transmitted to the server.

In one embodiment, the server further renews the watering schedule according to a weather information and transmits the renewed water schedule to the control device and the irrigation controller.

In one embodiment, the server generates the watering schedule according to the regional information and the evapotranspiration information as well as a soil profile information.

To achieve the above objective, the present also discloses a setting method of a watering schedule of an irrigation controller. The setting method includes the following steps of: receiving a plant information and a sprinkler information, which are inputted by a user; obtaining a position information of the irrigation controller; transmitting a regional information of the irrigation controller, which contains the position information, the plant information and the sprinkler information, to a server; receiving the watering schedule, which is generated by the server according to the regional information and an evapotranspiration information corresponding to the position information; and displaying the watering schedule to the user.

In one embodiment, the setting method further includes the following steps of: providing a modifying interface for the user to modify the watering schedule; and after the user modifies the watering schedule, transmitting the modified watering schedule to the irrigation controller.

In one embodiment, the setting method further includes a step of: receiving a soil profile information, which are inputted by a user. Herein, the regional information further includes the soil profile information.

In one embodiment, the setting method further includes a step of: providing a plant list, so that the user selects one item of the plant list as the plant information.

In one embodiment, the setting method further includes a step of: providing a sprinkler list, so that the user selects one item of the sprinkler list as the sprinkler information.

In one embodiment, the position information of the irrigation controller is inputted by the user.

As mentioned above, the server of the invention can calculate the watering schedule according to the regional information of the irrigation controller and the evapotranspiration information corresponding to the position information. Compared with the conventional manual setting, the invention can assist to set up the parameters (e.g. watering time) by machines so as to make the operation more convenience, thereby improving the performance of setting the watering schedule. Besides, the user, who does not have the professional gardening knowledge, can still set up a proper watering schedule for the local environment.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a flow chart of a setting method of a watering schedule of an irrigation controller according to a preferred embodiment of the invention;

FIG. 1B is a flow chart of another setting method of a watering schedule of an irrigation controller according to the preferred embodiment of the invention;

FIG. 2 is a schematic diagram of a control system according to a preferred embodiment of the invention; and

FIGS. 3, 4, 5, 6, 7, 8A, 8B and 8C are schematic diagrams showing the operation statuses of the control device according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

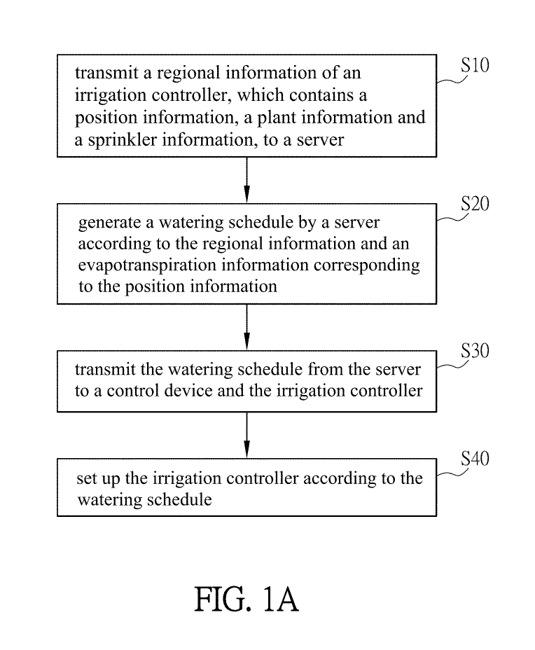

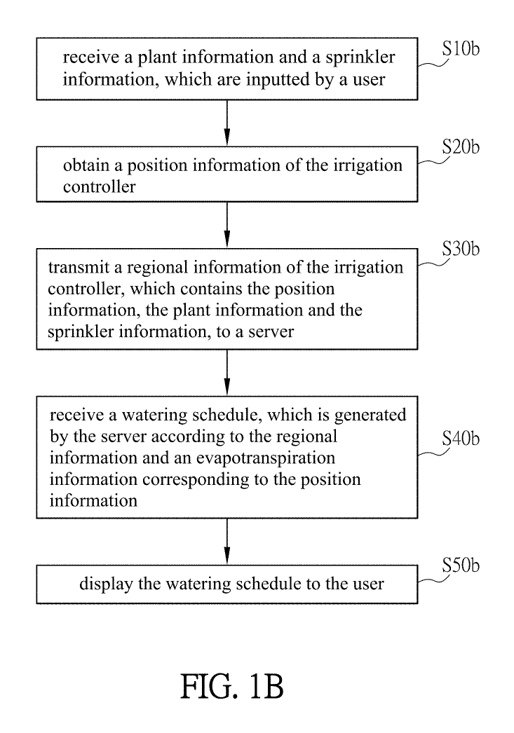

FIG. 1A is a flow chart of a setting method of a watering schedule of an irrigation controller according to a preferred embodiment of the invention. As shown in FIG. 1A, the setting method includes the following steps S10, S20, S30 and S40.

The step S10 is to transmit a regional information of an irrigation controller, which contains a position information, a plant information and a sprinkler information, to a server.

The step S20 is to generate a watering schedule by a server according to the regional information and an evapotranspiration information corresponding to the position information.

The step S30 is to transmit the watering schedule from the server to a control device and the irrigation controller.

The step S40 is to set up the irrigation controller according to the watering schedule.

FIG. 1B is a flow chart of another setting method of a watering schedule of an irrigation controller according to the preferred embodiment of the invention. As shown in FIG. 1B, the setting method includes the following steps S10b, S20b, S30b, S40b and S50b.

The step S10b is to receive a plant information and a sprinkler information, which are inputted by a user.

The step S20b is to obtain a position information of the irrigation controller.

The step S30b is to transmit a regional information of the irrigation controller, which contains the position information, the plant information and the sprinkler information, to a server.

The step S40b is to receive a watering schedule, which is generated by the server according to the regional information and an evapotranspiration information corresponding to the position information.

The step S50b is to display the watering schedule to the user.

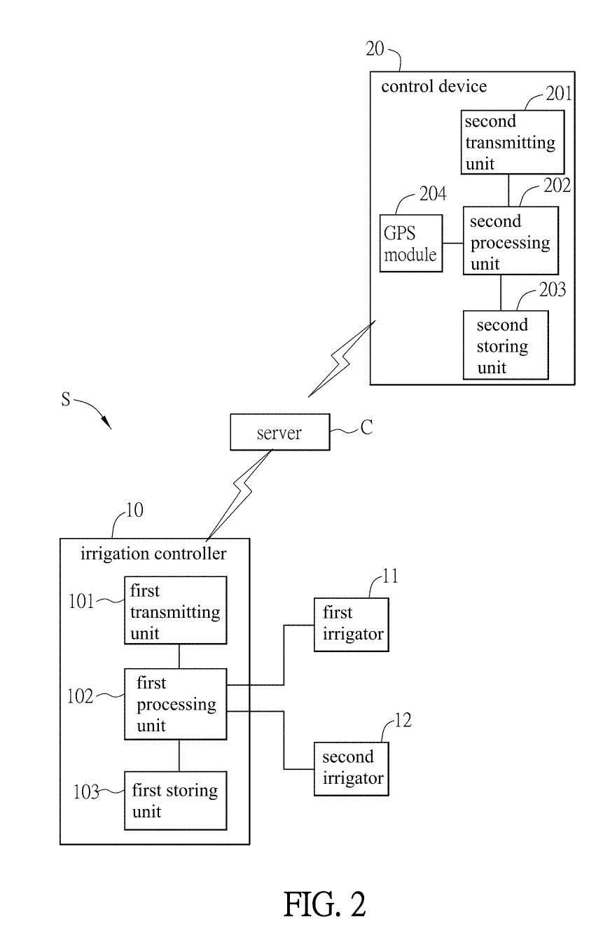

FIG. 2 is a schematic diagram of a control system S according to a preferred embodiment of the invention. The setting methods of FIGS. 1A and 1B can be applied to the control system S of FIG. 2. In more detailed, each of the setting methods of a water schedule of FIGS. 1A and 1B can be used to set up the watering schedule of the irrigation controller 10 of FIG. 2.

With reference to FIGS. 1A, 1B and 2, the control system S includes a server C, an irrigation controller 10, and at least one control device 20. The irrigation controller 10 is configured to control at least one irrigator to perform a watering procedure, and the control device 20 is configured to set up a watering schedule of the irrigation controller 10. In this embodiment, the irrigation controller 10 controls a first irrigator 11 and a second irrigator 12. To be noted, the number of the irrigators controlled by the irrigation controller 10 can be properly adjusted according to the actual requirement, and this invention is not limited. In some embodiments, the irrigation controller 10 and the first irrigator 11 (and/or the second irrigator 12) can be integrated into a single device, or they can be individual devices. In the case that the irrigation controller 10 and the first irrigator 11 are individual devices, the positions thereof are preferably closer.

The irrigation controller 10 includes at least one first transmitting unit 101, a first processing unit 102 and a first storing unit 103. The first processing unit 102 at least couples to the first transmitting unit 101 and the first storing unit 103, and the first transmitting unit 101 further links with the server C.

The control device 20 includes one or more second processing units 202 and one or more second storing units 203. Moreover, the control device 20 may further include at least one second transmitting unit 201 and a GPS module 204. The second transmitting unit 201, the second storing unit 203 and the GPS module 204 are individually coupled to the second processing unit 202. In this embodiment, the control device 20 includes one second processing unit 202 and one second storing unit 203.

In this embodiment, the server C links to the control device 20 and the irrigation controller 10, and the server C further receives the regional information of the irrigation controller 10. The regional information includes a position information, a plant information and a sprinkler information of the irrigation controller 10. After receiving the regional information of the irrigation controller 10, the server C generates a watering schedule according to the regional information and an evapotranspiration information corresponding to the position information, and then transmits the watering schedule to the irrigation controller 10 and the control device 20. Accordingly, the irrigation controller 10 can be set up according to the received watering schedule.

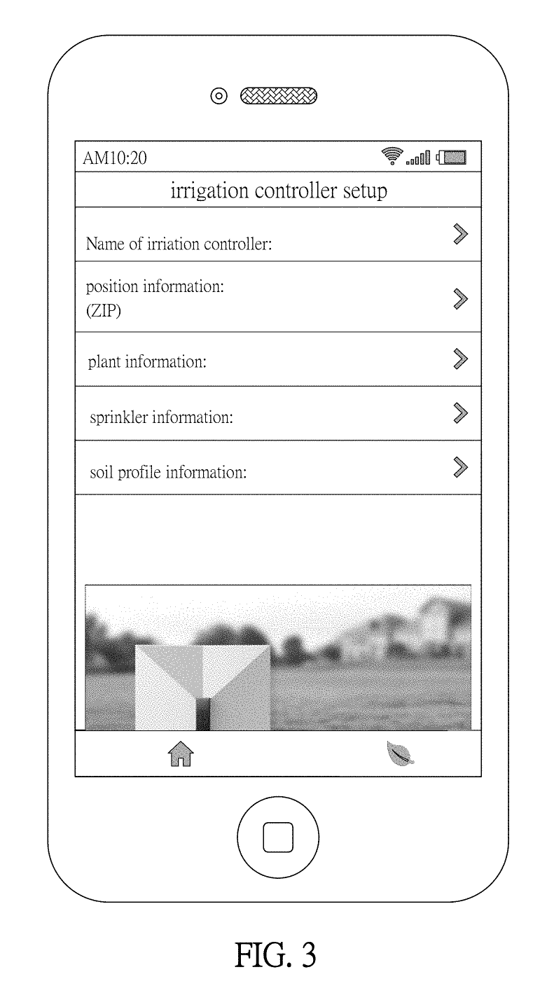

FIGS. 3 to 8C are schematic diagrams showing the operation statuses of the control device 20 according to the preferred embodiment of the invention.

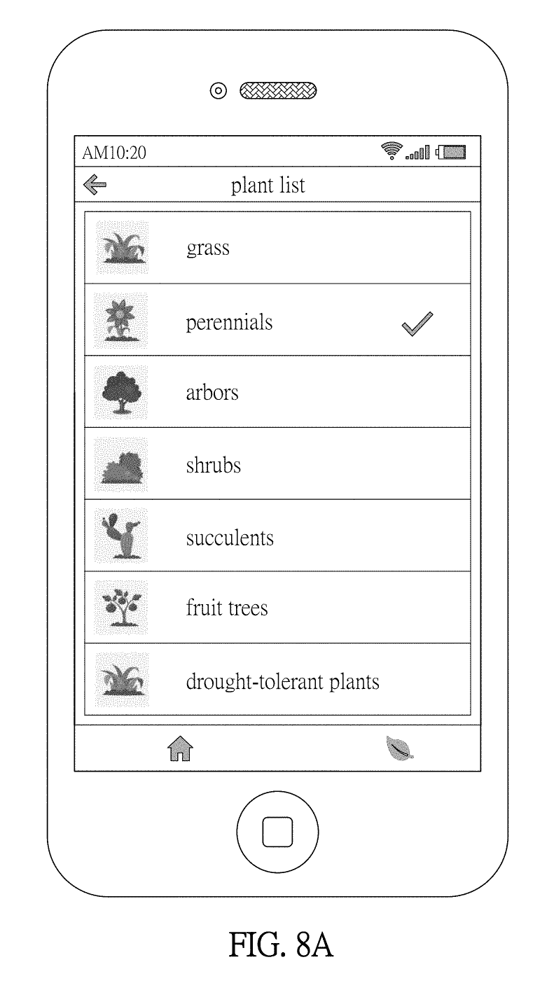

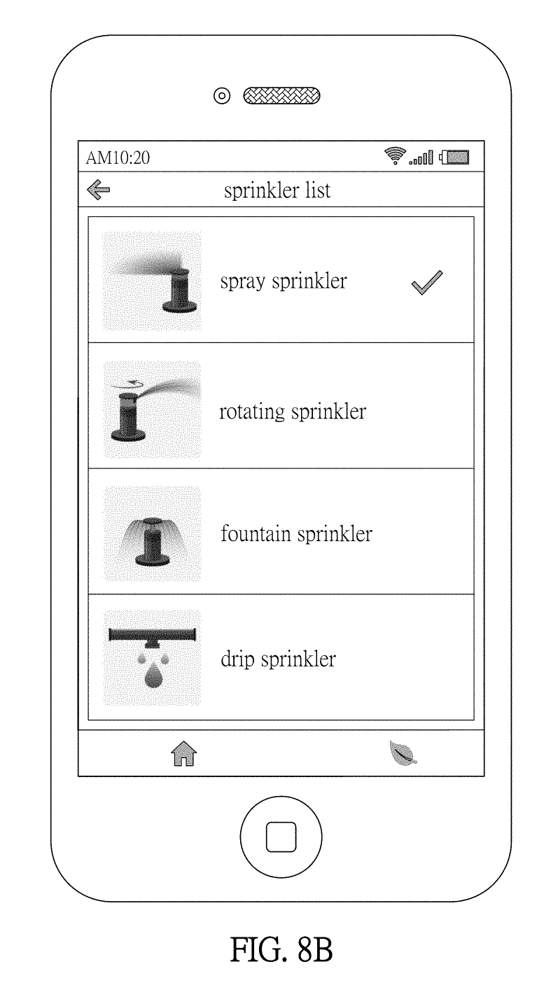

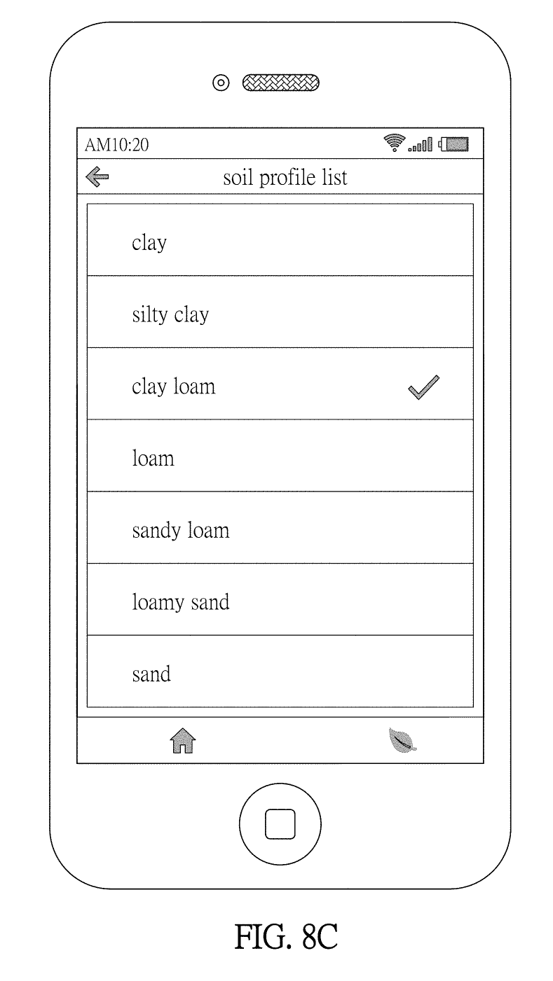

As shown in FIG. 3, the user can operate the control device 20 to set up the regional information of the irrigation controller 10, which includes the position information, the plant information, the sprinkler information and the soil profile information of the irrigation controller 10. To provide or input the plant information, a plant list (as shown in FIG. 8A) is provided to the user, and then the user selects at least one item from the plant list. For example, the plant information can be at least one of perennials, grass, arbors, shrubs, succulents, fruit trees and drought-tolerant plants. Moreover, the item of grass can have the sub-items of temperate grass turf and tropical grass turf (not shown). To provide or input the sprinkler information, a sprinkler list (as shown in FIG. 8B) is provided to the user, and then the user selects at least one proper item from the sprinkler list. For example, the sprinkler information can be at least one of a spray sprinkler, a rotating sprinkler, a fountain sprinkler, and a drip sprinkler. Similarly, to provide or input the soil profile information, a soil profile list (as shown in FIG. 8C) is provided to the user, and then the user selects at least one proper item from the soil profile list. For example, the soil profile information can be at least one of clay, silty clay, clay loam, loam, sandy loam, loamy sand, and sand. After setting up the regional information, the second processing unit 202 of the control device 20 controls the second transmitting unit 201 to transmit the inputted regional information (e.g. the position information, plant information, sprinkler information and soil profile information) of the irrigation controller 10 to the server C. Besides, the user may individually set up the plant and/or soil profile information within the watering range of the first irrigator 11 and the second irrigator 12, and the sprinkler information of the first irrigator 11 and the second irrigator 12. Accordingly, the server C can arrange the proper watering schedules for the first irrigator 11 and the second irrigator 12, respectively.

In this embodiment, the position information can be the zip number, address, GPS coordinates or IP address. For example, the zip number and address can be inputted by the user directly through the control device 20, and then transmitted to the server C. The GPS coordinates can be obtained by the GPS module 204 of the control device 20 and displayed on the position information column of the setup screen as shown in FIG. 3, and then the control device 20 transmits the position information containing the GPS coordinates to the server C through the second transmitting unit 201. In some aspects, the position information (e.g. the IP address) of the irrigation controller 10 can be transmitted to the server C through the first transmitting unit 101.

After receiving the regional information of the irrigation controller 10, the server C will obtain the information of evapotranspiration rate corresponding to the position information of the irrigation controller 10. In more detailed, after receiving the regional information of the irrigation controller 10, the server C will search the database thereof to find out the evapotranspiration information corresponding to the position or region. The evapotranspiration information may include the history evapotranspiration information or the current evapotranspiration information of the position or region. Herein, the history evapotranspiration information may include the daily average evapotranspiration rate of the previous day, the weekly average evapotranspiration rate of the previous week, or the monthly average evapotranspiration rate of the previous month. Besides, the database may further store the water rationing information of every region. For example, the server C can automatically and periodically collect the published water rationing rules to form the water rationing information. Otherwise, the operator can collect and input the published water rationing rules to the server C, and then the server C integrates the inputted data to form the water rationing information. Accordingly, after receiving the position information of the irrigation controller 10, the server C can also obtain the water rationing information corresponding to the position information of the irrigation controller 10.

Afterwards, the server C generates a proper watering schedule of the irrigation controller 10 according to the received regional information (including the position information, plant information, sprinkler information, and soil profile information) as well as the evapotranspiration information and/or a regional water rationing information of the region where the irrigation controller 10 is located. Then, the water schedule is transmitted to the irrigation controller 10 and the control device 20.

After the first transmitting unit 101 of the irrigation controller 10 receives the watering schedule from the server C, the first processing unit 102 can set up the irrigation controller 10 based on the watering schedule. Then, the first processing unit 102 further controls the operation parameters of the first irrigator 11 and the second irrigator 12, which connect to the irrigation controller 10. The operation parameters of the first irrigator 11 and the second irrigator 12 include the time point of starting watering, the time point of ceasing watering, the watering time, the watering frequency and/or the watering cycle.

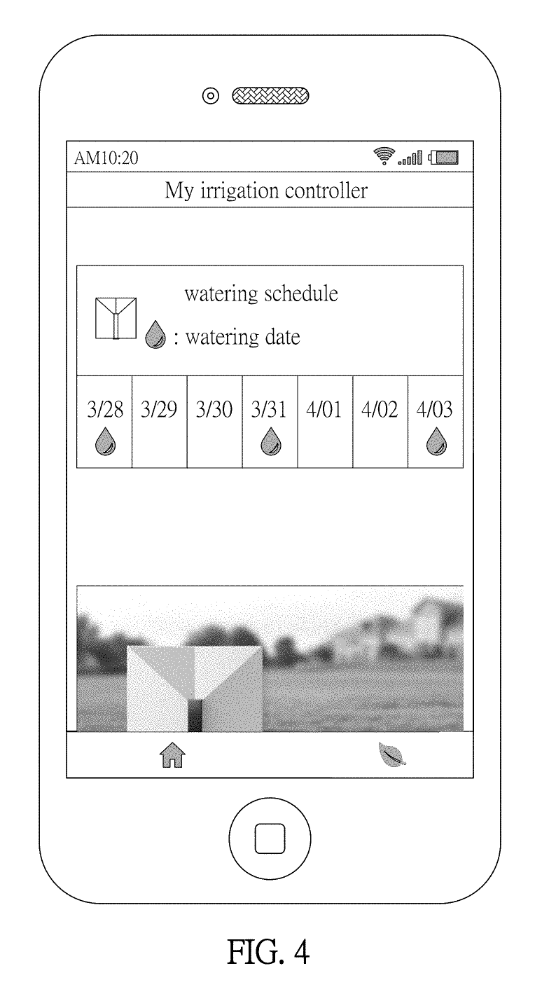

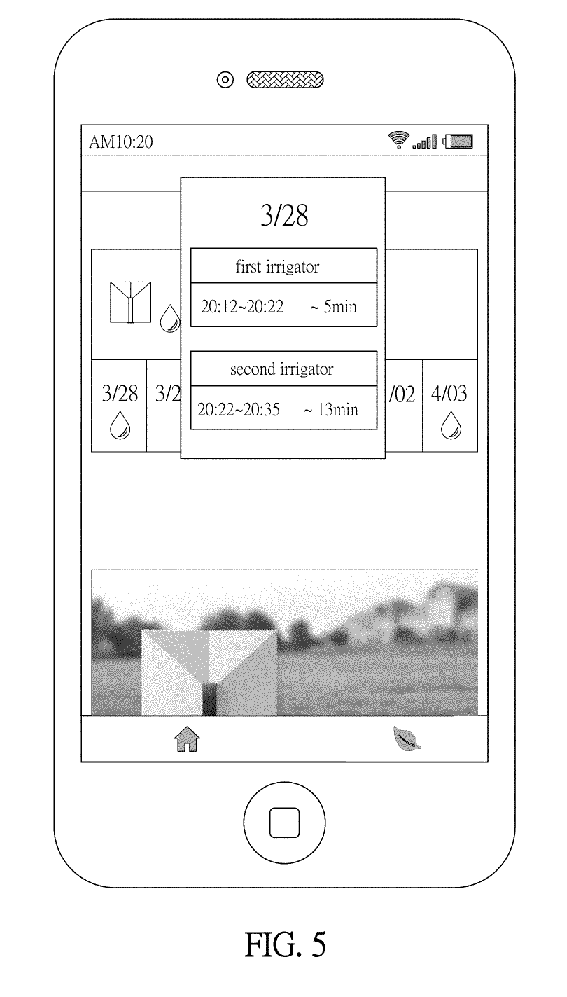

Referring to FIGS. 4 and 5, after the second transmitting unit 201 of the control device 20 receives the watering schedule from the server C, the received watering schedule is displayed on the control device 20 so that the user can easily find out the watering schedule of the irrigation controller 10. For example, the watering schedule of the irrigation controller 10 is to irrigate once per three days within one week from March 28 to April 3. Moreover, the first irrigator 11 is controlled to irrigate for 10 minutes (from 20:12 to 20:22) on March 28, and then the second irrigator 12 is controlled to irrigate for 13 minutes (from 20:22 to 20:35) on March 28.

Accordingly, the server C can calculate the watering schedule according to the regional information of the irrigation controller 10 and the evapotranspiration information corresponding to the position information. Compared with the conventional manual setting, the invention can assist to set up the parameters (e.g. watering time) by machines so as to make the operation more convenience, thereby improving the performance of setting the watering schedule. Besides, the user, who does not have the professional gardening knowledge, can still set up a proper watering schedule for the local environment of the irrigation controller 10.

In this embodiment, the server C can further periodically renew the watering schedule of the irrigation controller 10 according to a weather information, and transmits the renewed water schedule to the control device 20 and the irrigation controller 10. The renewing frequency of the watering schedule can be every day, every week or every month. If the renewing frequency is every day, the server C can retrieve the corresponding weather information (e.g. the forecast rainfall, relative humidity and/or temperature) according to the position information of the irrigation controller 10, and then calculate the new watering schedule according to the weather information, the evapotranspiration information, the plant information, the sprinkler information, and/or the soil profile information. Accordingly, the server C can renew the watering schedule of the irrigation controller 10 every day, and the renewed watering schedule can be transmitted to the control device 20 and the irrigation controller 10. The control device 20 and the irrigation controller 10 can receive the renewed watering schedule every day, so that the irrigation controller 10 can adjust the time point of starting watering, the time point of ceasing watering, the watering time, the watering frequency and/or the watering cycle. This is to adjust the watering schedule of the irrigation controller 10, so that the watering procedures of the first irrigator 11 and the second irrigator 12 can match up the local situation. Besides, the watering schedule can cover a week or a month. Thus, the irrigation controller 10 can properly control the operations of the first irrigator 11 and the second irrigator 12 even if the connection of the server C and the control device 20 or the irrigation controller 10 is interrupted.

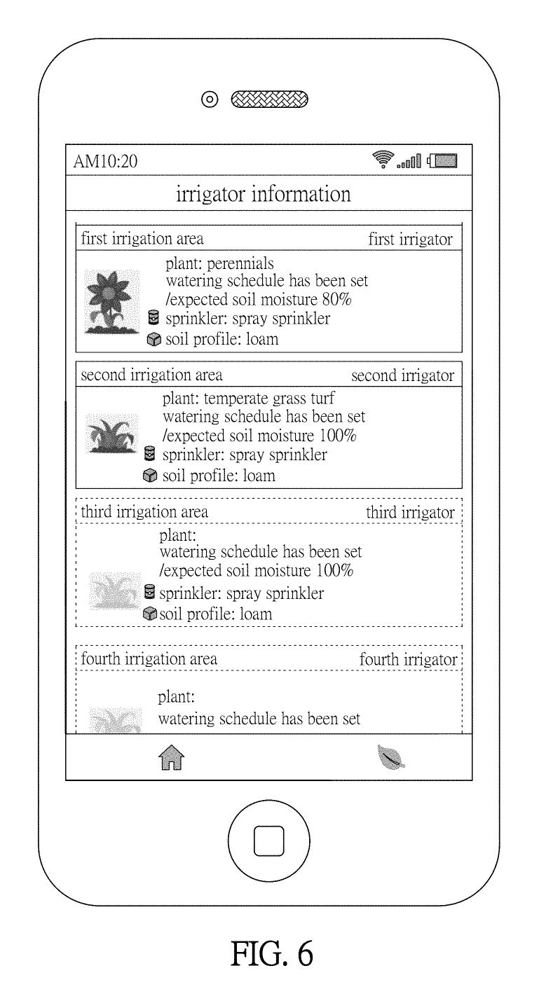

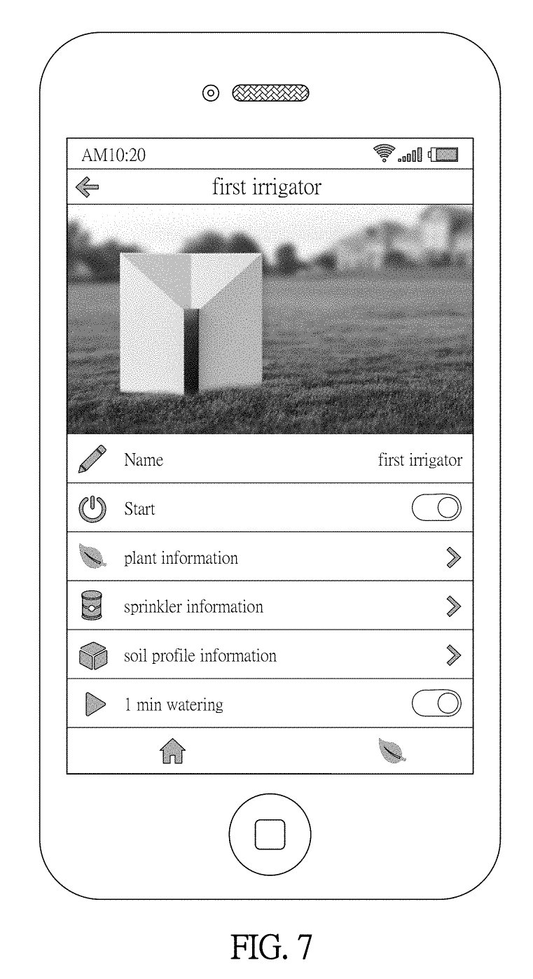

Referring to FIGS. 6 and 7, the control device 20 may further display the setup information of the first irrigator 11 and/or the second irrigator 12, including the plant information, sprinkler information, and/or soil profile information of the watering ranges of the first irrigator 11 and/or the second irrigator 12. Moreover, the control device 20 may further provide a modifying interface with a modifying menu (see FIG. 7), so that the user can operate the modifying interface to enable/disable the first irrigator 11 and/or the second irrigator 12 and manually modify the regional information (e,g. the plant information, sprinkler information and/or soil profile information) covered by the first irrigator 11 and/or the second irrigator 12. The modified plant information, sprinkler information and/or soil profile information are then transmitted to the server C. After receiving the modified regional information, the server C can generate a new watering schedule accordingly, and the generated new watering schedule is then transmitted to the control device 20 and the irrigation controller 10. The irrigation controller 10 sets up the time point of starting watering, the time point of ceasing watering, the watering time, the watering frequency and/or the watering cycle of the first irrigator 11 and/or the second irrigator 12 according to the new watering schedule.

The present invention also discloses a control device, which can be referred to the above embodiment, so the detailed description thereof will be omitted.

The present invention also discloses a non-transitory computer readable storage medium applied to the above-mentioned control device for setting a watering schedule of an irrigation controller. The non-transitory computer readable storage medium includes at least one program, and the program is executed to perform the setting method of the above embodiment, so the detailed description thereof will be omitted.

The present invention also discloses a irrigation controller, which can be referred to the above embodiment, so the detailed description thereof will be omitted.

In summary, the server of the invention can calculate the watering schedule according to the regional information of the irrigation controller and the evapotranspiration information corresponding to the position information. Compared with the conventional manual setting, the invention can assist to set up the parameters (e.g. watering time) by machines so as to make the operation more convenience, thereby improving the performance of setting the watering schedule. Besides, the user, who does not have the professional gardening knowledge, can still set up a proper watering schedule for the local environment.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A control system, comprising:
a control device;
an irrigation controller; and
a server linked to the control device and the irrigation controller for receiving a regional information of the irrigation controller, wherein the regional information comprises a position information, a plant information and a sprinkler information of the irrigation controller, the server generates a watering schedule according to the regional information and an evapotranspiration information corresponding to the position information, and then transmits the watering schedule to the irrigation controller and the control device, and the irrigation controller is set up according to the watering schedule.

2. The control system according to claim 1, wherein the position information is an IP address of the irrigation controller, and the IP address is transmitted from the irrigation controller to the server.

3. The control system according to claim 1, wherein the position information is inputted by a user via the control device and then transmitted to the server.

4. The control system according to claim 1, wherein the position information is retrieved by a GPS module of the control device and then transmitted to the server.

5. The control system according to claim 1, wherein the server further renews the watering schedule according to a weather information and transmits the renewed water schedule to the control device and the irrigation controller.

6. The control system according to claim 1, wherein the server generates the watering schedule according to the regional information and the evapotranspiration information as well as a soil profile information.

7. A control device configured for linking with a server for setting a watering schedule of an irrigation controller, the control device comprising:
one or more processing units; and
one or more storing units coupling to the one or more processing units, wherein the one or more storing units store one or more instructions, and when the one or more processing units execute the one or more instructions, the one or more processing units execute following steps of:
transmitting a regional information of the irrigation controller to the server, wherein the regional information comprises a position information, a plant information and a sprinkler info nation of the irrigation controller; and
receiving a watering schedule transmitted from the server, wherein the server generates the watering schedule according to the regional information of the irrigation controller and an evapotranspiration information corresponding to the position information.

8. The control device according to claim 7, wherein the position information is inputted by a user via the control device and then transmitted to the server.

9. The control device according to claim 7, wherein the position information is retrieved by a GPS module of the control device and then transmitted to the server.

10. The control device according to claim 7, wherein the server further renews the watering schedule according to a weather information and transmits the renewed water schedule to the control device and the irrigation controller.

11. The control system according to claim 7, wherein the server generates the watering schedule according to the regional information and the evapotranspiration information as well as a soil profile information.

12. A non-transitory computer readable storage medium applied to a control device, wherein the control device links with a server for setting a watering schedule of an irrigation controller, the non-transitory computer readable storage medium comprises at least one program, and the program is executed to perform following steps of:
transmitting a regional information of the irrigation controller to a server, wherein the regional information comprises a position information, a plant information and a sprinkler information of the irrigation controller; and
receiving a watering schedule transmitted from the server, wherein the server generates the watering schedule according to the regional information of the irrigation controller and an evapotranspiration information corresponding to the position information.

13. The non-transitory computer readable storage medium according to claim 12, wherein the position information is inputted by a user via the control device and then transmitted to the server.

14. The non-transitory computer readable storage medium according to claim 12, wherein the position information is retrieved by a GPS module of the control device and then transmitted to the server.

15. The non-transitory computer readable storage medium according to claim 12, wherein the server further renews the watering schedule according to a weather information and transmits the renewed water schedule to the control device and the irrigation controller.

16. The non-transitory computer readable storage medium according to claim 12, wherein the server generates the watering schedule according to the regional information and the evapotranspiration information as well as a soil profile information.

17. A setting method of a watering schedule of an irrigation controller, comprising steps of:
receiving a plant information and a sprinkler information, which are inputted by a user;
obtaining a position information of the irrigation controller;
transmitting a regional information of the irrigation controller, which contains the position information, the plant information and the sprinkler information, to a server;
receiving the watering schedule, which is generated by the server according to the regional information and an evapotranspiration information corresponding to the position information; and
displaying the watering schedule to the user.

18. The setting method according to claim 17, further comprising steps of:
providing a modifying interface for the user to modify the watering schedule; and
after the user modifies the watering schedule, transmitting the modified watering schedule to the irrigation controller.

19. The setting method according to claim 17, further comprising a step of:
receiving a soil profile information, which are inputted by a user, wherein the regional information further comprises the soil profile information.

20. The setting method according to claim 17, further comprising a step of:
providing a plant list, so that the user selects one item of the plant list as the plant information.

21. The setting method according to claim 17, further comprising a step of:
providing a sprinkler list, so that the user selects one item of the sprinkler list as the sprinkler information.

22. The setting method according to claim 17, wherein the position information of the irrigation controller is inputted by the user.
